(19) United States
(12) Patent Application Publication
(10) Pub. No.: US 2025/0260131 A1
(43) Pub. Date: Aug. 14, 2025

(54) SECONDARY BATTERY AND METHOD FOR MANUFACTURING SECONDARY BATTERY

(71) Applicant: ISUZU MOTORS LIMITED, Yokohama-shi (JP)

(72) Inventor: Hiroyuki MATSUMOTO, Fujisawa-shi (JP)

(21) Appl. No.: 18/971,809

(22) Filed: Dec. 6, 2024

(30) Foreign Application Priority Data
Feb. 14, 2024 (JP) 2024-020039

(51) Int. Cl. H01M 50/489; H01M 10/04

(52) U.S. Cl. CPC H01M 50/489; H01M 10/0468

(57) ABSTRACT

A secondary battery includes: a positive electrode layer; a negative electrode layer; a solid electrolyte layer (a first solid electrolyte layer and a second solid electrolyte layer) provided between the positive electrode layer and the negative electrode layer, containing a solid electrolyte through which lithium ions migrate; and a separator that is in contact with the solid electrolyte layer between the positive electrode layer and the negative electrode layer. A plurality of holes for supplying the electrolytic solution contained within the separator to the solid electrolyte layer are formed in the surface of the separator.

### CROSS-REFERENCE TO RELATED APPLICATIONS

The present application claims priority to Japanese Patent Applications number 2024-20039, filed on Feb. 14, 2024 contents of which are incorporated herein by reference in their entirety.

### BACKGROUND OF THE INVENTION

The present disclosure relates to a secondary battery and a method for manufacturing the secondary battery. In recent years, an all-solid-state battery using a solid electrolyte has been developed as a lithium ion secondary battery from the viewpoint of safety or the like (see Japanese Unexamined Patent Application Publication No. 2023-165328). In the all-solid-state battery, a solid electrolyte layer through which lithium ions can migrate is provided between a positive electrode layer and a negative electrode layer.

In the all-solid-state battery, lithium may be precipitated on the negative electrode layer side during charging. In particular, in cases of abnormalities such as deterioration of the all-solid-state battery, lithium is not taken into the negative electrode layer and precipitates from the surface of the negative electrode layer in the form of dendrites (acicular crystals). Then, when the precipitation of lithium within the solid electrolyte layer further progresses and reaches the positive electrode layer, an internal short circuit may occur.

### BRIEF SUMMARY OF THE INVENTION

The present disclosure has been made in view of these points, and its object is to suppress precipitation of lithium in a solid electrolyte layer.

A first aspect of the present disclosure provides a secondary battery including: a positive electrode layer; a negative electrode layer; a solid electrolyte layer provided between the positive electrode layer and the negative electrode layer, containing a solid electrolyte through which lithium ions migrate; and a separator in contact with the solid electrolyte layer between the positive electrode layer and the negative electrode layer, wherein a plurality of holes for supplying an electrolytic solution contained within the separator to the solid electrolyte layer are formed in the surface of the separator.

A second aspect of the present disclosure provides a method for manufacturing a secondary battery including: preparing a positive electrode layer, a negative electrode layer, a solid electrolyte layer containing a solid electrolyte through which lithium ions migrate, and a separator containing an electrolytic solution therein; sandwiching the solid electrolyte layer and the separator between the positive electrode layer and the negative electrode layer so that solid electrolyte layer is in contact with the separator; and pressurizing the separator having a plurality of holes for supplying the electrolyte solution to the solid electrolyte layer by fastening the positive electrode layer and the negative electrode layer.

### BRIEF DESCRIPTION OF THE DRAWINGS

FIG. 1 is a schematic diagram illustrating a configuration of a secondary battery 1 according to an embodiment.

FIG. 2 is a schematic view for explaining an internal short circuit in a secondary battery 100 according to a comparative example.

FIG. 3 is a schematic view for explaining a configuration of a separator 50.

FIG. 4 is a schematic view showing a hole 53 included in an upper surface 51a of the separator 50.

FIG. 5 is a schematic view showing a state in which precipitation of lithium is suppressed.

FIG. 6 is a flowchart illustrating a manufacturing process of the secondary battery 1.

FIG. 7 is a schematic diagram illustrating a secondary battery 1 according to a modification example.

### DETAILED DESCRIPTION OF THE INVENTION

Hereinafter, the present disclosure will be described through exemplary embodiments, but the following exemplary embodiments do not limit the disclosure according to the claims, and not all of the combinations of features described in the exemplary embodiments are necessarily essential to the solution means of the disclosure.

### <Configuration of a Secondary Battery>

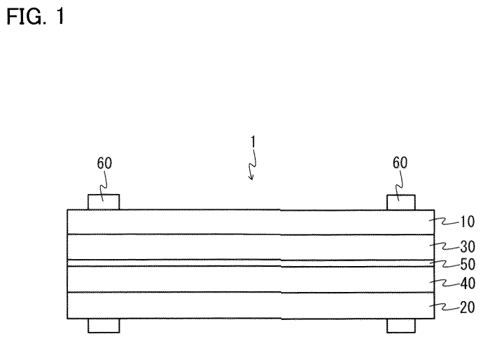

FIG. 1 is a schematic diagram illustrating a configuration of a secondary battery 1 according to one embodiment. The secondary battery 1 is a lithium ion secondary battery in which carrier ions are lithium ions. Specifically, the secondary battery 1 is an all-solid-state battery with a laminated structure, integrating a positive electrode layer, a negative electrode layer, and a solid electrolyte layer to realize high energy density of the battery.

As shown in FIG. 1, the secondary battery 1 includes a positive electrode layer 10, a negative electrode layer 20, a first solid electrolyte layer 30, a second solid electrolyte layer 40, a separator 50, and fastening members 60.

The positive electrode layer 10 contains a positive electrode active material. As the positive electrode active material, sulfur, lithium nickel oxide, lithium cobalt oxide, an oxide in which a transition metal is combined with lithium in a fixed ratio, lithium manganate oxide, lithium iron phosphate oxide, or the like can be used. The transition metal is nickel, cobalt, manganese, or the like. The positive electrode layer 10 may contain a solid electrolyte in addition to the positive electrode active material.

The negative electrode layer 20 contains a negative electrode active material. Specifically, the negative electrode active material is an alloy-based negative electrode such as hard carbon, graphite, or silicon, or metallic lithium. Similar to the positive electrode layer 10, the negative electrode layer 20 may contain a solid electrolyte in addition to the negative electrode active material. The negative electrode layer 20 and the positive electrode layer 10 have the same shape and are specifically formed in a rectangular plate-like shape.

The first solid electrolyte layer 30 and the second solid electrolyte layer 40 are provided between the positive electrode layer 10 and the negative electrode layer 20. As shown in FIG. 1, the first solid electrolyte layer 30 faces the positive electrode layer 10, and the second solid electrolyte layer 40 faces the negative electrode layer 20. Specifically, the first solid electrolyte layer 30 is in contact with the positive electrode layer 10, and the second solid electrolyte layer 40 is in contact with the negative electrode layer 20.

The first solid electrolyte layer 30 and the second solid electrolyte layer 40 have lithium ion conductivity. The first solid electrolyte layer 30 and the second solid electrolyte layer 40 each include a solid electrolyte through which lithium ions can migrate within each respective layer. The solid electrolyte is, for example, a known oxide-based solid electrolyte or sulfide-based solid electrolyte.

A first solid electrolyte included in the first solid electrolyte layer 30 facing the positive electrode layer 10 may be different from a second solid electrolyte included in the second solid electrolyte layer 40 facing the negative electrode layer 20. For example, the first solid electrolyte is an electrolyte with oxidation resistance, and the second solid electrolyte is an electrolyte with reduction resistance. The first solid electrolyte may be the same as the second solid electrolyte.

The separator 50 is provided between the positive electrode layer 10 and the negative electrode layer 20. Specifically, the separator 50 is sandwiched between the first solid electrolyte layer 30 and the second solid electrolyte layer 40. Here, the separator 50 is in contact with both the first solid electrolyte layer 30 and the second solid electrolyte layer 40. For example, the thickness of the separator 50 may be less than the thicknesses of the positive electrode layer 10, the negative electrode layer 20, the first solid electrolyte layer 30, and the second solid electrolyte layer 40. In this case, the rigidity of the separator 50 is lower than the rigidity of the positive electrode layer 10, the negative electrode layer 20, the first solid electrolyte layer 30, and the second solid electrolyte layer 40. The thickness and rigidity of the separator 50 are not limited to those described above.

Although details will be described later, the separator 50 is made of a porous base material and contains an electrolytic solution therein. Therefore, the electrolytic solution inside the separator 50 is easily supplied to (penetrates into) the first solid electrolyte layer 30 and the second solid electrolyte layer 40.

The fastening members 60 fasten the positive electrode layer 10 and the negative electrode layer 20. Specifically, the fastening members 60 fasten the positive electrode layer 10 and the negative electrode layer 20 with the first solid electrolyte layer 30, the second solid electrolyte layer 40, and the separator 50 sandwiched therebetween. Here, the fastening members 60 each include a bolt and a nut, and sandwich the positive electrode layer 10 and the negative electrode layer 20 with the bolt and the nut. The fastening members 60 are provided, for example, at the four corners of the rectangular positive electrode layer 10 and the rectangular negative electrode layer 20.

By having the fastening members 60 fasten the positive electrode layer 10 and the negative electrode layer 20, the separator 50 sandwiched between the positive electrode layer 10 and the negative electrode layer 20 is pressurized by the fastening members 60 via the positive electrode layer 10 and the negative electrode layer 20. The separator 50 with low rigidity is easily deformed by being pressurized by a fastening force of the fastening members 60. As the separator 50 is deformed, the electrolytic solution therein easily seeps out, and the seeped-out electrolytic solution is easily supplied to the first solid electrolyte layer 30 and the second solid electrolyte layer 40.

### <Detailed Configuration of a Separator>

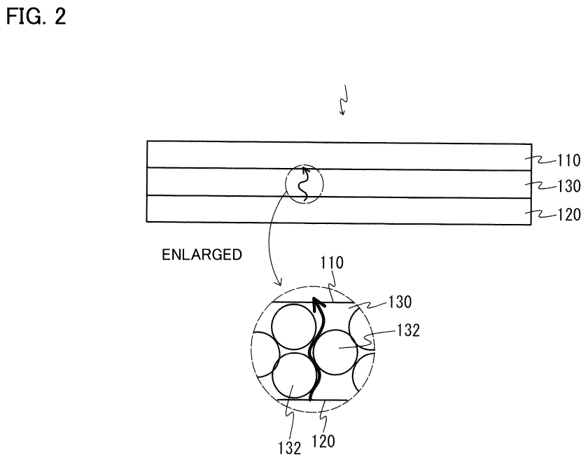

Before describing the detailed configuration of the separator 50 in the present embodiment, precipitation of lithium that occurs in a secondary battery 100 according to a comparative example in which the separator 50 is not provided will be described with reference to FIG. 2.

FIG. 2 is a schematic view for explaining an internal short circuit in the secondary battery 100 according to the comparative example. The secondary battery 100 has a laminated structure including a positive electrode layer 110, a negative electrode layer 120, and a solid electrolyte layer 130.

In FIG. 2, an area where lithium precipitation has occurred is shown as an enlarged view. Here, an uneven part exists in the negative electrode layer 120, causing current to concentrate at this part, which in turn leads to the occurrence of lithium precipitation from said area. As shown in the enlarged view of FIG. 2, lithium precipitates in the form of dendrites (acicular crystals) within the solid electrolyte layer 130. The lithium precipitated from the negative electrode layer 120 progresses through the gaps between particles 132, which are solid electrolytes within the solid electrolyte layer 130, and reaches the positive electrode layer 110, as indicated by a bold line in the enlarged view. When the precipitated lithium reaches the positive electrode layer 110, an internal short circuit would occur between the negative electrode layer 20 and the positive electrode layer 110.

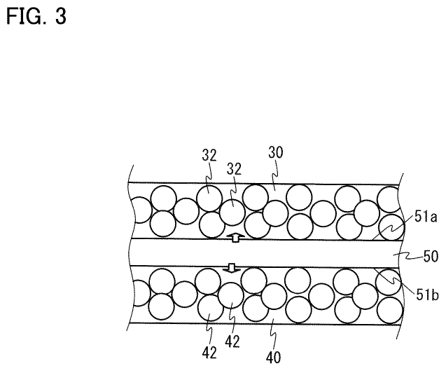

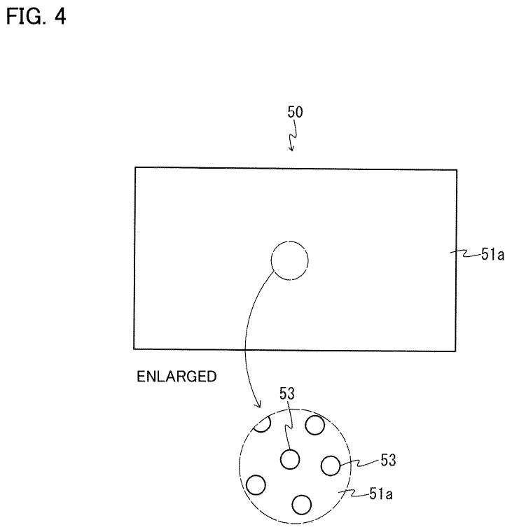

A detailed configuration of the separator 50 according to the present embodiment for suppressing the occurrence of the internal short circuit described above will be explained with reference to FIGS. 3 to 5. FIG. 3 is a schematic view for explaining the configuration of the separator 50. FIG. 4 is a schematic view showing a hole 53 included in an upper surface 51a of the separator 50.

The separator 50 contains an electrolytic solution therein. The electrolytic solution within the separator 50 is, for example, 1 mol/L LiPF6 EC/DMC. LiPF6 is lithium hexafluorophosphate, EC is ethylene carbonate, and DMC is dimethyl carbonate. Moreover, it is desirable that the electrolytic solution within the separator 50 has low volatility characteristics and is, for example, a high concentration electrolytic solution or an electrolytic solution using a low boiling point solvent. Furthermore, it is desirable that the electrolytic solution within the separator 50 reacts with the precipitated lithium stably and does not generate gas during the reaction.

Since the separator 50 is made of the porous base material, the electrolytic solution within the separator 50 is supplied to the first solid electrolyte layer 30 and the second solid electrolyte layer 40, as indicated by arrows in FIG. 3. The electrolytic solution contained within the separator 50 is supplied to the first solid electrolyte layer 30 and the second solid electrolyte layer 40 during the manufacturing of the secondary battery 1, for example.

More specifically, during the manufacturing of the secondary battery 1, when the fastening members 60 fasten the positive electrode layer 10 and the negative electrode layer 20 while the positive electrode layer 10, the first solid electrolyte layer 30, the separator 50, the second solid electrolyte layer 40, and the negative electrode layer 20 are laminated, as shown in FIG. 1, the electrolytic solution within the separator 50 is supplied to the first solid electrolyte layer 30 and the second solid electrolyte layer 40. When the positive electrode layer 10 and the negative electrode layer 20 are fastened by the fastening members 60, the separator 50 deforms, making it easier for the electrolytic solution within the separator 50 to flow out to the first solid electrolyte layer 30 and the second solid electrolyte layer 40. In particular, reducing the thickness of the separator 50 increases its deformability, which can promote the supply of the electrolytic solution within the separator 50 to the first solid electrolyte layer 30 and the second solid electrolyte layer 40.

The electrolytic solution supplied into the first solid electrolyte layer 30 disperses so as to fill the gaps between particles 32, which are solid electrolytes within the first solid electrolyte layer 30. Similarly, the electrolytic solution supplied into the second solid electrolyte layer 40 disperses so as to fill the gaps between particles 42, which are solid electrolytes within the second solid electrolyte layer 40.

A plurality of holes 53 for supplying the electrolytic solution contained within the separator 50 to the solid electrolyte layer are formed in the surface of the separator 50. The plurality of holes 53 are formed at predetermined intervals across the entire surface of the separator 50. This arrangement facilitates an even distribution of the electrolytic solution within the solid electrolyte layer through the holes 53.

The plurality of holes 53 are formed on both the upper surface 51a and a lower surface 51b of the separator 50. The upper surface 51a of the separator 50 is a surface facing the first solid electrolyte layer 30, and the lower surface 51b is a surface facing the second solid electrolyte layer 40. Therefore, in the present embodiment, the upper surface 51a corresponds to a first surface of the separator 50, and the lower surface 51b corresponds to a second surface.

As shown in the enlarged view of FIG. 4, a plurality of holes 53 are formed at predetermined intervals across the upper surface 51a. Although FIG. 4 shows the holes 53 only in the enlarged view for descriptive convenience, the holes 53 are actually formed across the entire upper surface 51a. In addition, in FIG. 4, the shapes of the holes 53 are circular, but this is not a limitation, and the holes 53 may be rectangular or other shapes. The electrolytic solution within the separator 50 is supplied to the first solid electrolyte layer 30 through the holes 53 on the upper surface 51a. It should be noted that, although the plurality of holes 53 are described as being formed at predetermined intervals, the present embodiment is not limited thereto, and the intervals between the holes 53 may be uneven.

Similarly to the upper surface 51a, a plurality of holes 53 are formed at predetermined intervals across the lower surface 51b. The electrolytic solution within the separator 50 is supplied to the second solid electrolyte layer 40 through the holes 53 on the lower surface 51b. Although the plurality of holes 53 on the lower surface 51b are described as being formed at predetermined intervals, the present embodiment is not limited thereto, and the intervals between the holes 53 may be uneven. In the present embodiment, the holes 53 formed on the upper surface 51a correspond to first holes, and the holes 53 formed on the lower surface 51b correspond to second holes.

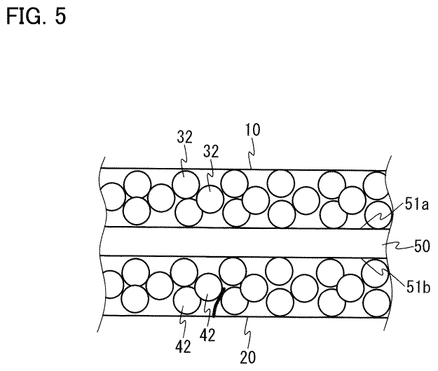

The electrolytic solution supplied from the separator 50 disperses so as to fill the gaps between the particles 32, which are the solid electrolytes within the first solid electrolyte layer 30, and the gaps between the particles 42, which are the solid electrolytes within the second solid electrolyte layer 40, whereby precipitation of lithium is suppressed as shown in FIG. 5.

FIG. 5 is a schematic view showing a state in which precipitation of lithium is suppressed. In FIG. 5, the precipitation state of lithium is indicated by a thick line. Here, it is assumed that the electrolytic solution is dispersed in the first solid electrolyte layer 30 and the second solid electrolyte layer 40. Specifically, the electrolytic solution fills the gaps between the particles 32 and the gaps between the particles 42. The lithium precipitated from the negative electrode layer 20 is in contact with the electrolytic solution within the second solid electrolyte layer 40. When lithium comes into contact with the electrolytic solution, the lithium reacts with the electrolytic solution to form a lithium compound having non-electron conductivity, so that precipitation of lithium is suppressed. Thus, the precipitated lithium can be prevented from reaching the positive electrode layer 10.

The sizes of the holes 53 in the lower surface 51b may be different from the sizes of the holes 53 in the upper surface 51a. For example, the sizes of the holes 53 in the lower surface 51b are larger than the sizes of the holes 53 in the upper surface 51a. In this case, the electrolytic solution is more easily supplied to the second solid electrolyte layer 40 than to the first solid electrolyte layer 30. As a result, precipitation of lithium in the second solid electrolyte layer 40 is easily suppressed. The sizes of the holes 53 in the upper surface 51a may be larger than the sizes of the holes 53 in the lower surface 51b.

The interval between the holes 53 in the lower surface 51b may be different from the interval between the holes 53 in the upper surface 51a. For example, the interval between the holes 53 in the lower surface 51b is smaller than the interval between the holes 53 in the upper surface 51a. In this case, many holes 53 are formed in the lower surface 51b, and the electrolytic solution is easily supplied to the second solid electrolyte layer 40. As a result, precipitation of lithium in the second solid electrolyte layer 40 is easily suppressed. It should be noted that the present embodiment is not limited to the above, and the interval between the holes 53 in the upper surface 51a may be smaller than the interval between the holes 53 in the lower surface 51b.

The capacity of the electrolytic solution contained within the separator 50 is preset. For example, the capacity of the electrolytic solution is equivalent to the total volume of the gaps between the solid electrolytes (particles 32 within the first solid electrolyte layer 30 and particles 42 within second solid electrolyte layer 40). As a result, the electrolytic solution can fill the entire set of gaps between the solid electrolytes, thereby suppressing lithium precipitation within the first solid electrolyte layer 30 and the second solid electrolyte layer 40.

However, the present embodiment is not limited to this arrangement, and the capacity of the electrolytic solution may be less than the total volume of the gaps between the solid electrolytes (particles 32 within the first solid electrolyte layer 30 and particles 42 within the second solid electrolyte layer 40) by a predetermined amount. For example, the capacity of the electrolytic solution may alternatively be equivalent only to the volume of the gaps between the solid electrolytes within the second solid electrolyte layer 40. Even in such a case, the electrolytic solution still disperses over a wide area within the first solid electrolyte layer 30 and the second solid electrolyte layer 40, thereby suppressing lithium precipitation.

### <Manufacturing Method for the Secondary Battery>

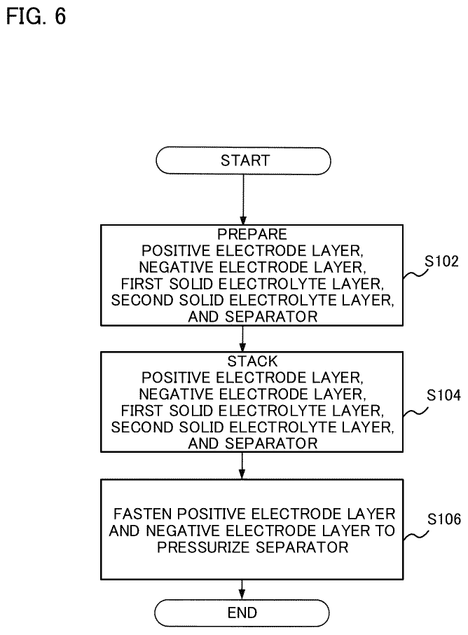

FIG. 6 is a flowchart illustrating a manufacturing process of the secondary battery 1.

First, an operator prepares the positive electrode layer 10, the negative electrode layer 20, the first solid electrolyte layer 30, the second solid electrolyte layer 40, and the separator 50 (step S102). Here, an electrolytic solution is contained within the separator 50.

Next, the operator stacks the prepared positive electrode layer 10, negative electrode layer 20, first solid electrolyte layer 30, second solid electrolyte layer 40, and separator 50 (step S104). Specifically, the operator sandwiches the first solid electrolyte layer 30 and the second solid electrolyte layer 40, with the separator 50 positioned between them so that each is in contact with the separator 50, between the positive electrode layer 10 and the negative electrode layer 20.

Next, the operator fastens the positive electrode layer 10 and the negative electrode layer 20 together using the fastening members 60, which pressurizes the separator 50 (step S106). The electrolytic solution inside the separator 50, deformed as a result of the applied pressure, is supplied to the first solid electrolyte layer 30 and the second solid electrolyte layer 40 through the holes 53 in the surfaces of the separator 50. The supply amount of electrolytic solution is proportional to the fastening force applied by the fastening members 60. Specifically, the greater the fastening force of the fastening members 60, the greater the amount of deformation of the separator 50, thereby increasing the supply amount of the electrolyte. Therefore, the operator can adjust the fastening force of the fastening members 60 so that the electrolytic solution inside the separator 50 is supplied to the first solid electrolyte layer 30 and the second solid electrolyte layer 40 in a desired amount.

### Modification Example

In the embodiment described above, the secondary battery 1 includes the first solid electrolyte layer 30 and the second solid electrolyte layer 40. However, it is not limited to this configuration and may include one of the first solid electrolyte layer 30 and the second solid electrolyte layer 40.

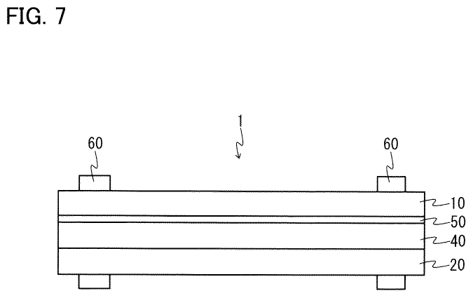

FIG. 7 is a schematic diagram illustrating a secondary battery 1 according to a modification example. The secondary battery 1 according to the modification example includes the positive electrode layer 10, the negative electrode layer 20, the second solid electrolyte layer 40, the separator 50, and the fastening members 60, but does not include the first solid electrolyte layer 30. The separator 50 is sandwiched between the positive electrode layer 10 and the second solid electrolyte layer 40. The separator 50 according to the modification example has the same configuration as the separator 50 illustrated in FIG. 1 described above. Specifically, the separator 50 contains the electrolytic solution therein, and the plurality of holes 53 (FIG. 4) for supplying the electrolytic solution to the second solid electrolyte layer 40 are formed in the surface of the separator 50.

Also in the modification example, the electrolytic solution within the separator 50 is supplied to the second solid electrolyte layer 40 through the holes 53, dispersing into the first solid electrolyte layer 30. In this way, even if lithium is precipitated from the negative electrode layer 20, the lithium reacts with the electrolytic solution within the second solid electrolyte layer 40 upon contact, thereby suppressing further lithium precipitation in the second solid electrolyte layer 40. As a result, the deposited lithium can be prevented from coming into contact with the positive electrode layer 10.

### Effects of the Embodiment

The secondary battery 1 of the present embodiment described above includes the separator 50 in contact with the solid electrolyte layer (specifically, both the first solid electrolyte layer 30 and the second solid electrolyte layer 40) disposed between the positive electrode layer 10 and the negative electrode layer 20. The plurality of holes 53 for supplying the electrolytic solution contained within the separator 50 to the solid electrolyte layer are formed in the surface of the separator 50. In this configuration, the electrolytic solution supplied from the separator 50 disperses into the solid electrolyte layer. Specifically, the electrolytic solution disperses between the particles, which are the solid electrolytes within the solid electrolyte layer. Consequently, even if lithium precipitates from the negative electrode layer 20, the lithium will react with the electrolytic solution within the solid electrolyte layer to form a lithium compound, which suppresses the progression of lithium precipitation in the solid electrolyte layer. As a result, it is possible to prevent the precipitated lithium from contacting the positive electrode layer 10, thereby preventing the occurrence of an internal short circuit.

The present disclosure is explained on the basis of the exemplary embodiments. The technical scope of the present disclosure is not limited to the scope explained in the above embodiments and it is possible to make various changes and modifications within the scope of the disclosure. For example, all or part of the apparatus can be configured with any unit which is functionally or physically dispersed or integrated. Further, new exemplary embodiments generated by arbitrary combinations of them are included in the exemplary embodiments. Further, effects of the new exemplary embodiments brought by the combinations also have the effects of the original exemplary embodiments.

What is claimed is:

1. A secondary battery comprising:
a positive electrode layer;
a negative electrode layer;
a solid electrolyte layer provided between the positive electrode layer and the negative electrode layer, containing a solid electrolyte through which lithium ions migrate; and
a separator in contact with the solid electrolyte layer between the positive electrode layer and the negative electrode layer, wherein
a plurality of holes for supplying an electrolytic solution contained within the separator to the solid electrolyte layer are formed in the surface of the separator.

2. The secondary battery according to claim 1, wherein
the solid electrolyte layer comprises a first solid electrolyte layer facing the positive electrode layer and a second solid electrolyte layer facing the negative electrode layer, and
the separator is sandwiched between the first solid electrolyte layer and the second solid electrolyte layer.

3. The secondary battery according to claim 2, wherein
a plurality of first holes for supplying the electrolytic solution to the first solid electrolyte layer are formed in a first surface of the separator facing the first solid electrolyte layer,
a plurality of second holes for supplying the electrolytic solution to the second solid electrolyte layer are formed in a second surface of the separator facing the second solid electrolyte layer, and
the sizes of the second holes are different from the sizes of the first holes.

4. The secondary battery according to claim 2, wherein
a plurality of first holes for supplying the electrolytic solution to the first solid electrolyte layer are formed in a first surface of the separator facing the first solid electrolyte layer,
a plurality of second holes for supplying the electrolytic solution to the second solid electrolyte layer are formed in a second surface of the separator facing the second solid electrolyte layer, and
an interval between the second holes is different from an interval between the first holes.

5. The secondary battery according to claim 2, wherein
a first solid electrolyte included in the first solid electrolyte layer is different from a second solid electrolyte included in the second solid electrolyte layer.

6. The secondary battery according to claim 1, further comprising:
fastening members that fasten the positive electrode layer and the negative electrode layer with the solid electrolyte layer and the separator sandwiched therebetween, wherein
the separator is pressurized by the fastening members via the positive electrode layer and the negative electrode layer.

7. The secondary battery according to claim 1, wherein
the capacity of the electrolyte solution is equivalent to the total volume of gaps between the solid electrolytes in the solid electrolyte layer.

8. The secondary battery according to claim 1, wherein
the capacity of the electrolytic solution is less than the total volume of gaps between the solid electrolytes in the solid electrolyte layer by a predetermined amount.

9. The secondary battery according to claim 1, wherein
the plurality of holes are formed at predetermined intervals across the entire surface of the separator.

10. A method for manufacturing a secondary battery, the method comprising:
preparing a positive electrode layer, a negative electrode layer, a solid electrolyte layer containing a solid electrolyte through which lithium ions migrate, and a separator containing an electrolytic solution therein;
sandwiching the solid electrolyte layer and the separator between the positive electrode layer and the negative electrode layer so that solid electrolyte layer is in contact with the separator; and
pressurizing the separator having a plurality of holes for supplying the electrolyte solution to the solid electrolyte layer, by fastening the positive electrode layer and the negative electrode layer.

11. The method of manufacturing the secondary battery according to claim 10, wherein the pressurizing includes adjusting a fastening force between the positive electrode layer and the negative electrode layer applied by fastening members so that the separator to be pressurized deforms.
